(19) United States
(12) Patent Application Publication
(10) Pub. No.: US 2005/0174772 A1
(43) Pub. Date: Aug. 11, 2005

(54) Lighting devices and apparatus

(75) Inventor: Jun Hui Gun, Huizhou City (CN)

Correspondence Address: BURNS DOANE SWECKER & MATHIS L L P, POST OFFICE BOX 1404, ALEXANDRIA, VA, 22313-1404, US

(73) Assignee: Quantum Lighting Products Ltd., Kowloon (CN)

(21) Appl. No.: 10/775,067

(22) Filed: Feb. 11, 2004

(51) Int. Cl. F21V 7/00

(52) U.S. Cl. 362/247

(57) ABSTRACT

A lighting apparatus including main light reflective means and a plurality of light-emitting sources which are adapted for producing light beams generally along a prescribed direction, said main light reflective means including a main light reflective surface which is adapted for reflecting light emanating from at least one of said light-emitting sources towards said general prescribed direction, at least some of said plurality of light-emitting sources being disposed outside said main light reflective surface of said main light reflective means and including individual reflective means for reflecting light from the individual light-emitting sources which are disposed outside said light reflective means along said general prescribed direction.

### FIELD OF THE INVENTION

This invention relates to lighting devices and apparatus and, more particularly, to portable lighting devices and apparatus such as torches or flashlights. More specifically, although of course not solely limited thereto, this invention relates to torches or flashlights with both incandescent and light-emitting diode light sources.

### BACKGROUND OF THE INVENTION

Many lighting devices include light reflective means to direct and concentrate light emanating from a diffused light source along a prescribed direction. For example, an automobile head lamp or the lighting head of a torch or flashlight typically includes an incandescent and diffusing light source placed at the focal point of a parabolic reflector so that most of the light emanating from the incandescent light source will be collected and collimated along the axis of a parabolic reflector.

With advance in light technology, many new types of the diffused and focused light sources are now suitable for use in such lighting devices. For example, ultra-bright light-emitting diodes (LEDs) with many colour options have been increasingly used in lighting devices, especially portable lighting devices.

In many lighting devices, it is desirable to include a plurality of light sources or light sources of different colours so as to provide a combination of lighting effects. At the same time, it is sometimes desirable if there is no or minimal adverse interference between the different types of light sources in order to generate a plurality of distinctive illumination effect. While a typical LED usually includes a reflector as well as a collimating lens to focus and direct light towards a general direction, it is noted that an LED usually has a characteristic “viewing angle” which means the light emitted by a LED is likely to prematurely interfere with light emanating from adjacent light sources as soon as the light is emitted from the individual sources. Hence, it will be highly desirable if there can be provided lighting sources utilizing different types of light sources, for example, diffused and focused, to achieve optimal lighting effect while alleviating or minimizing adverse or undesirable interference between adjacent light sources. In the following, the term torch and flashlight is used interchanging.

### OBJECT OF THE INVENTION

Hence, it is an object of the present invention to provide lighting devices or apparatus with different types of lighting sources which are collimated along a substantially prescribed direction with minimal adverse interference between adjacent lighting sources. At a minimum, it is an object of the present invention of the present invention to provide the public with a useful choice of lighting devices or apparatus.

### SUMMARY OF THE INVENTION

According to the present invention, there is provided a lighting apparatus including main light reflective means and a plurality of light-emitting sources which are adapted for producing light beams generally along a prescribed direction, said main light reflective means including a main light reflective surface which is adapted for reflecting light emanating from at least one of said light-emitting sources towards said general prescribed direction, at least some of said plurality of light-emitting sources being disposed outside said main light reflective surface of said main light reflective means and including individual reflective means for reflecting light from the individual light-emitting sources which are disposed outside said light reflective means along said general prescribed direction.

Preferably, said plurality of light-emitting sources including incandescent and light-emitting-diode light sources, at least one incandescent light source being disposed inside said main reflective means and surrounded by said main light reflective surface, and a plurality of light-emitting diodes being disposed outside and surrounding said main light reflective surface.

Preferably, said plurality of light-emitting sources including incandescent and light-emitting-diode light sources, at least one incandescent light source being disposed inside said main reflective means and surrounded by said main light reflective surface, and a plurality of light-emitting diodes being disposed outside and surrounding said main light reflective surface.

Preferably, said main light reflective surface having a generally parabolic shape, the axis of said paraboloid being substantially parallel with said prescribed direction, a plurality of indentations for housing some of said plurality of light-emitting sources being distributed along the outer periphery of the expanded end of said parabolic shaped main reflective surface.

Preferably, said plurality of indentations interrupt the substantially circular cross-section of said expanded end of said parabolic shaped main reflective surface and said indentation extends radially inwards from the said outer periphery of the expanded end of said main reflective surface towards the axis of the paraboloid.

Preferably, the longitudinal axis of said indentation also substantially parallel to the axis of the parabolic shaped main reflective surface and being adapted to house an light-emitting-diode so that the beam axis of said light-emitting-diode being substantially parallel to or converge towards the axis of said parabolic shaped main reflective surface.

Preferably, an incandescent light source being disposed at or near the focal point of said parabolic main reflective surface, and a plurality of light-emitting diodes being housed in said plurality of indentations, surrounding the outer periphery of said main reflective surface and axially away from said incandescent light source.

Preferably, said reflective surface and said indentations being integrally moulded as an unitary piece with said indentations evenly distributed around the circular outer rim of said parabolic main reflective surface.

Preferably, said indentation including an axially extending channel for housing and aligning an light-emitting diode so that the light emitted from said light-emitting diode being substantially parallel to or converging towards the axis of said parabolic main reflective surface.

Preferably, said lighting apparatus further including an integral base member with a housing comprising a base and a plurality of axially extending receptacles, said axially extending receptacles being spatially distributed corresponding to said indentations on said main reflective surface and said receptacles being adapted for receiving light-emitting diodes, said base member being adapted for receiving an incandescent light source and for coupling with said main light reflective means to form a modular sub-assembly comprising a plurality of incandescent and light-emitting diode light sources.

Preferably, each said light-emitting diode including a reflector for reflecting light generally along said prescribed direction.

Preferably, said light-emitting diodes comprise grounds of light-emitting diodes of different colours.

Preferably, said indentation including an arcuate surface, said arcuate surface being convex towards said prescribed direction and extends longitudinally parallel to said axis of said parabolic main reflective surface.

Preferably, said apparatus being a flashlight with a head portion and a handle portion, said main reflective means, said light-emitting sources being disposed for light emission towards a transparent window disposed at said head portions.

### BRIEF DESCRIPTION OF THE DRAWINGS

Preferred embodiments of the present invention will be explained in further detail below by way of examples and with reference to the accompanying drawings, in which:—

FIG. 1 shows a front perspective view of a flashlight torch showing a first preferred embodiment of the present invention of a lighting apparatus,

FIG. 2 is a front view of the flashlight of FIG. 1,

FIG. 3 is a partially disassembled view of the flashlight of FIG. 1,

FIG. 4 is another partial disassembled view of the flashlight of FIG. 1,

FIG. 5 shows a partially enlarged view of the head portion of the disassembled flashlight of FIG. 3,

FIG. 6 shows a partial cross-section of the head portion of the flashlight of FIG. 1,

FIG. 7 shows another partial cross-section of the front portion of the flashlight of FIG. 1,

FIG. 8 shows an enlarged view of a main reflective member and the light sources support member of the flashlight of FIG. 1, and

FIG. 9 is a perspective view from another angle of the parts of FIG. 8.

### DETAILED DESCRIPTION OF THE PREFERRED EMBODIMENTS

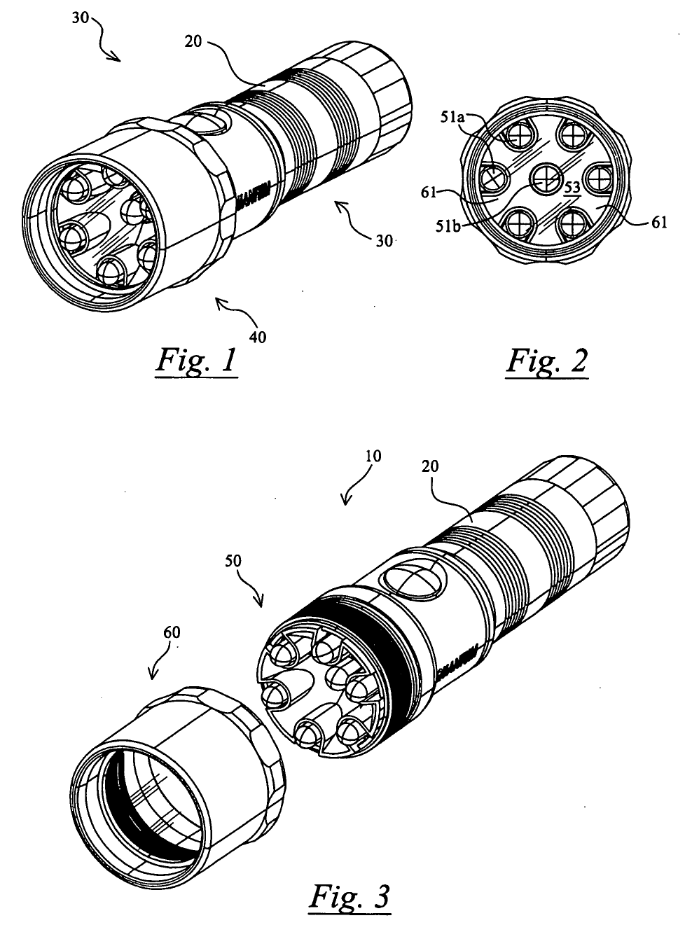

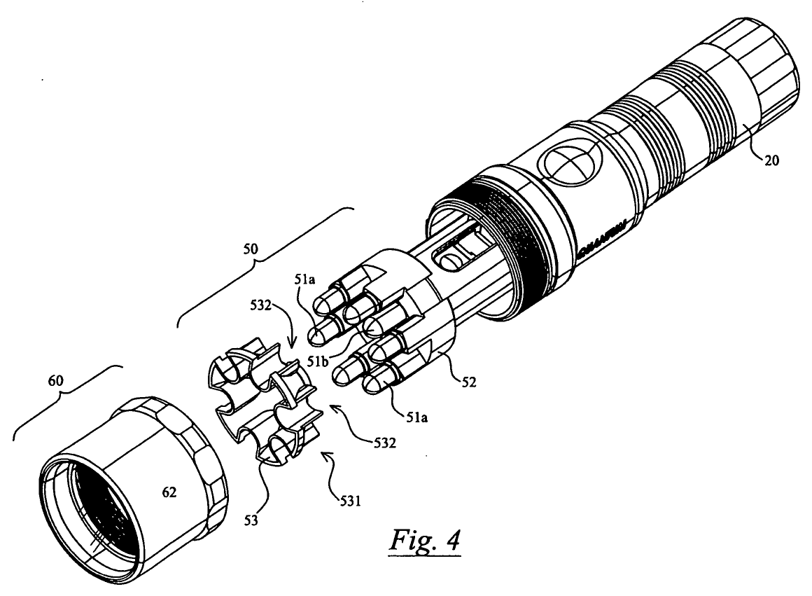

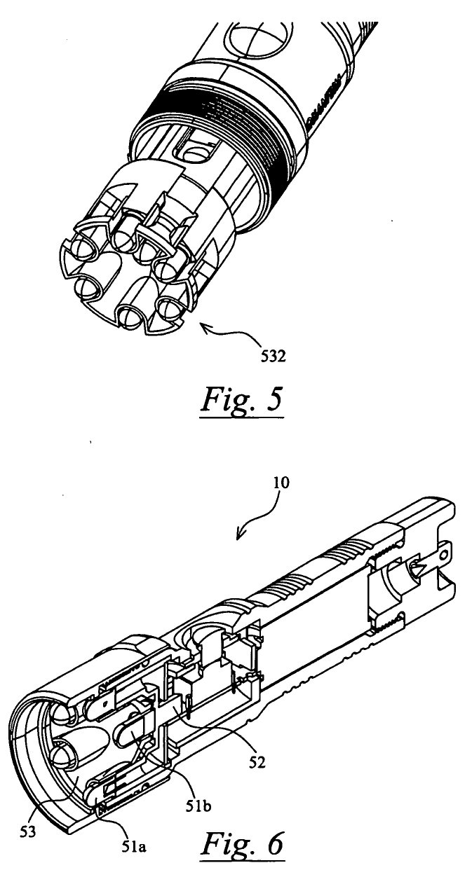

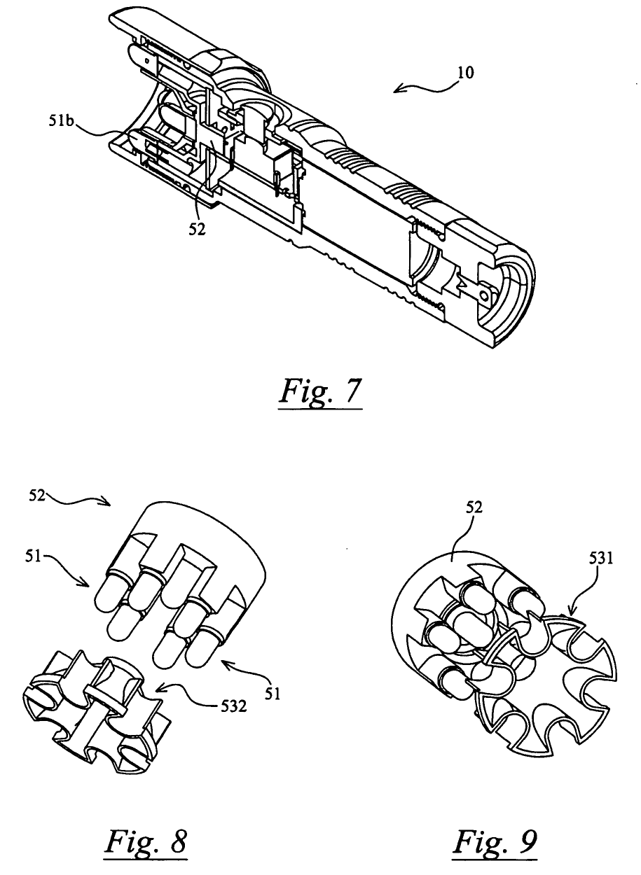

Referring to the FIGS. 1-9, there is shown a torch or flashlight of a first preferred embodiment of the present invention of a lighting apparatus. The flashlight 10 comprises a main housing 20 with a handle portion 30 and a head portion 40. The handle portion comprises a cylindrical or prismatic compartment for receiving a battery or a plurality of batteries with contacts for supplying electrical power to the light sources housed in the head portion. The handle portion may comprise a conductive tubular portion which forms a conductive path between the end terminals of the batteries without the need of additional wirings. Where the handle portion comprises an insulated handle portion, conductive wirings may be used to provide such a conductive path for the battery circuit.

The head portion 40 forms the luminescent head of the lighting apparatus and comprises a light-emitting head 50 and a head housing 60. The head housing comprises a transparent window 61 which is surrounded by a non-transparent collar 62. The non-transparent collar is substantially tubular with internal threads for coupling to the approaching end portion of the handle portion of the handle. The transparent window comprises a glass or transparent plastic lens which is attached to the front end of the non-transparent collar via a sealing ring to alleviate the risk of leakage. The light-emitting head 50 comprises a plurality of discrete light sources 51, a base support member 52 for mounting the light sources and reflective means for main light reflecting light emitted from the light sources and surrounded by its reflective surface(s) generally along a prescribed direction. In this example, the prescribed direction is towards the transparent window in this embodiment. The main light reflective means comprises a main light reflective surface 53 which is adapted for reflecting light emanating from at least one of the light-emitting sources surrounded by the main light reflective surface towards the general prescribed direction with at least some of the plurality of light-emitting sources being disposed outside the main light reflective surface.

Referring to FIGS. 1-4, the main light reflective means comprises a main reflective member 531 with its internal surface coated with a shinny or reflective material. The main reflective member 531 is generally a reflective cup resembling the shape of a paraboloid with a plurality of indentations 532 formed at the expanded, open end of the parabolic cup. The indentations comprise partially cylindrical surfaces which extend along a direction which is substantially parallel to the axis of the paraboloid and towards the transparent window. The plurality of indentations are distributed along the outer periphery of the main reflective cup and are for housing some of the light-emitting sources mounted on the base support member of the luminescent head.

In the present specific example, the luminescent head comprises a plurality of light-emitting diodes (LED) 51a surrounding an incandescent light bulb which is disposed at or near the focal point of the parabolic main reflective surface. The main reflective cup are shaped and dimensioned so that the totality of the plurality of satellite light-emitting sources 51a and 51b, that is, light sources disposed outside the main reflective surface, are still within the boundary of the paraboloid while being disposed outside the main reflective surface. The plurality of light-emitting sources are mounted on a base supported member so that the plurality of light sources protrudes from the base support member with the satellite LEDs 51a closer to the transparent window than the incandescent bulb at the middle.

The main reflective member is shaped with a central aperture and with the plurality of peripheral indentations shaped corresponding to the shape of the protruding light-emitting sources so that when the main reflective member is coupled with the base support member 52. The light-emitting source mounted at the centre of the base support member will protrude through the central aperture of the main reflective member into the main reflective cup and surrounded by the main reflective surface while the peripheral (or satellite) light-emitting sources disposed at the periphery of the base support member are separated from the main reflective surface by the non-transparent wall or partition of the main reflective member. By disposing the light-emitting sources so that a plurality of light sources are mounted outside the main reflective surface, a combination of lighting effects can be formed. For example, the plurality of light-emitting sources can be selectively, sequentially or randomly activated and de-activated. For example, in the present specific embodiment, the light source at the centre of the main reflective surface is an incandescent light bulb 51b which can be turned on on its own or in combination with selected members of the plurality of light sources. The surrounding plurality of light-emitting sources can be white LEDs or LEDs of a plurality of colours which can be selectively activated in combination or on its own. By disposing the plurality of light sources outside the main reflective member, a combination of distinctive lighting effects can be achieved.

As can be seen from the Figures, a substantial portion of the peripheral light-emitting diode is separated from the main reflective surface by a non-transparent wall so that the light emitting from the peripheral LEDs will be transmitted along their respective viewing angles and generally along the axis of the paraboloid or other prescribed directions without loss of generality.

In the present embodiment, LEDs with an individual reflective member and a collimating lens re used so that light will be emitted along a generally prescribed direction and not more transversely across the wall of the reflective cup. By selectively aligning the directions of the light beams generated by the plurality of light-emitting sources, the overall or collimated light beam may have a selective light strength or light effects, for example, of different colour and brightness. Furthermore, by having the indentations comprising an arcuate wall which generally extends along the axis of the parabolic reflector and convex towards the centre of the main reflective surface, it will be appreciated that the overall contour or exterior of the main reflective member is still substantially parabolic so that the head portion has an overall cylindrical shape compactable with conventional flashlights.

While the present invention has been explained by reference to the preferred embodiments described above, it will be appreciated that the embodiments are illustrated as examples to assist understanding of the present invention and are not meant to be restrictive on the scope and spirit of the present invention. The scope of this invention should be determined from the general principles and spirit of the invention as described above. In particular, variations or modifications which are obvious or trivial to persons skilled in the art, as well as improvements made on the basis of the present invention, should be considered as falling within the scope and boundary of the present invention.

Furthermore, while the present invention has been explained by reference to a flashlight with an incandescent light bulb disposed at the centre of or focal point of the reflective cup, it should be appreciated that the invention can apply, whether with or without modification, to other arrangements or combination of light sources without loss of generality.

1. A lighting apparatus including main light reflective means and a plurality of light-emitting sources which are adapted for producing light beams generally along a prescribed direction, said main light reflective means including a main light reflective surface which is adapted for reflecting light emanating from at least one of said light-emitting sources towards said general prescribed direction, at least some of said plurality of light-emitting sources being disposed outside said main light reflective surface of said main light reflective means and including individual reflective means for reflecting light from the individual light-emitting sources which are disposed outside said light reflective means along said general prescribed direction.

2. A lighting apparatus according to claim 1, wherein said plurality of light-emitting sources including incandescent and light-emitting-diode light sources, at least one incandescent light source being disposed inside said main reflective means and surrounded by said main light reflective surface, and a plurality of light-emitting diodes being disposed outside and surrounding said main light reflective surface.

3. Alighting apparatus according to claim 1, wherein said main light reflective surface having a generally parabolic shape, the axis of said paraboloid being substantially parallel with said prescribed direction, a plurality of indentations for housing some of said plurality of light-emitting sources being distributed along the outer periphery of the expanded end of said parabolic shaped main reflective surface.

4. A lighting apparatus according to claim 3, wherein said plurality of indentations interrupt the substantially circular cross-section of said expanded end of said parabolic shaped main reflective surface and said indentation extends radially inwards from the said outer periphery of the expanded end of said main reflective surface towards the axis of the paraboloid.

5. A lighting apparatus according to claim 4, wherein the longitudinal axis of said indentation also substantially parallel to the axis of the parabolic shaped main reflective surface and being adapted to house an light-emitting-diode so that the beam axis of said light-emitting-diode being substantially parallel to or converge towards the axis of said parabolic shaped main reflective surface.

6. A lighting apparatus according to claim 3, wherein an incandescent light source being disposed at or near the focal point of said parabolic main reflective surface, and a plurality of light-emitting diodes being housed in said plurality of indentations, surrounding the outer periphery of said main reflective surface and axially away from said incandescent light source.

7. A lighting apparatus according to claim 6, wherein said reflective surface and said indentations being integrally moulded as an unitary piece with said indentations evenly distributed around the circular outer rim of said parabolic main reflective surface.

8. A lighting apparatus according to claim 6, wherein said indentation including an axially extending channel for housing and aligning an light-emitting diode so that the light emitted from said light-emitting diode being substantially parallel to or converging towards the axis of said parabolic main reflective surface.

9. A lighting apparatus according to claim 8, further including an integral base member with a housing comprising a base and a plurality of axially extending receptacles, said axially extending receptacles being spatially distributed corresponding to said indentations on said main reflective surface and said receptacles being adapted for receiving light-emitting diodes, said base member being adapted for receiving an incandescent light source and for coupling with said main light reflective means to form a modular sub-assembly comprising a plurality of incandescent and light-emitting diode light sources.

10. A lighting apparatus according to claim 6, wherein each said light-emitting diode including a reflector for reflecting light generally along said prescribed direction.

11. A lighting apparatus according to claim 10, wherein said light-emitting diodes comprise grounds of light-emitting diodes of different colours.

12. A lighting apparatus according to claim 10, wherein said indentation including an arcuate surface, said arcuate surface being convex towards said prescribed direction and extends longitudinally parallel to said axis of said parabolic main reflective surface.

13. A lighting apparatus according to claim 12, said apparatus being a flashlight with a head portion and a handle portion, said main reflective means, said light-emitting sources being disposed for light emission towards a transparent window disposed at said head portion.
